(19) United States
(12) Patent Application Publication
(10) Pub. No.: US 2025/0013764 A1
(43) Pub. Date: Jan. 9, 2025

(54) Method And Device For Monitoring Hart Commands

(71) Applicant: Electriccite de France, Paris (FR)

(72) Inventors: Christophe Merieux, Avon (FR); Tien Tuan Dang, Emerainville (FR)

(73) Assignee: Electriccite de France, Paris (FR)

(21) Appl. No.: 18/710,864

(22) PCT Filed: Nov. 18, 2022
(86) PCT No.: PCT/FR2022/052124

§ 371 Date: May 16, 2024

(30) Foreign Application Priority Data
Nov. 19, 2021 (FR) FR2112275

(51) Int. Cl. G06F 21/60; G05B 19/042; G06F 21/85

(52) U.S. Cl. CPC G06F 21/606; G05B 19/0425; G06F 21/85

(57) ABSTRACT

A method implemented by a monitoring device for monitoring a current loop, the method comprising: intercepting (102) a command in accordance with the HART protocol circulating over a current loop; extracting (104) from the command a first datum indicating whether or not the command was transmitted by a primary master in the sense of the HART protocol, and a second datum indicating a type of the command; and generating (106), or not generating, an alert according to the extracted data, the alert indicating that the command is potentially abnormal and/or hazardous.

### FIELD OF THE INVENTION

This invention relates to a method and device for monitoring commands according to the HART protocol.

### Prior Art

The HART (Highway Addressable Remote Transducer) protocol was developed in the mid-1980s to allow the two-way communication of diagnostic and configuration information between different devices. It allows both the configuration of connected items of equipment but also the escalation of operational data provided by the sensors integrated into these items of field equipment.

A very large number of instrumented systems (approximately 40 million according to the Fieldbuses foundation) use the HART protocol for its simplicity and its robustness, in particular for equipment located over very long distances, due to the use of a 4/20 mA current loop. The current loop is dependable and highly immune to environmental interference over long communication distances. It is therefore no surprise that it is still widely used in industry at present.

However, the HART protocol does have security flaws. Specifically, it is possible to inject unauthorized commands into a current loop, which are liable to modify or even alter the operation of certain devices connected to the loop.

### SUMMARY OF THE INVENTION

One aim of the invention is to detect and improve the security of a current loop which uses the HART protocol.

For this purpose provision is made, according to a first aspect, for a method for monitoring a current loop, the method comprising the following steps implemented by a monitoring device:
intercepting a command in accordance with the HART protocol circulating over a current loop,
extracting from the command a first datum indicating whether or not the command was transmitted by a primary master in the sense of the HART protocol, and a second datum indicating a type of the command,
generating, or not generating, an alert according to the extracted data, the alert indicating that the command is potentially abnormal and/or hazardous.

A primary master of a HART current loop is intended to be used by a manufacturer, intermittently, for maintenance purposes. By contrast, a secondary master of a HART current loop is intended to be used much more frequently by an operator of the current loop. During a maintenance session, hazardous commands, i.e. commands which are especially liable to alter the behavior of a device, are transmitted by the primary master. Thus, a command that was transmitted by a primary master has statistically more chances of having severe repercussions on the correct operation of the system. Similarly, the type of the intercepted command provides information about these repercussions. For example, a command parameterizing the internal operation of a slave on the current loop is more critical than a command that remains a simple status. It is therefore a hazardous command. Thus, taking into consideration the type of the command and whether or not the command was transmitted by a primary master to decide whether or not an alert must be generated allows the method to attract the attention of a user to particularly hazardous situations.

The method according to the first aspect may further comprise the following optional features, taken alone or in combination whenever such a combination makes sense technically.

Preferably, the alert is generated if the first datum indicates that the transmitter is a primary master.

Preferably, the method comprises a comparison of the type of the command indicated by the second datum with reference data, and the alert is generated or not generated according to the comparison.

Preferably, the alert is not generated if the following conditions are all met: the first datum indicates that the command was not transmitted by a primary master and the second datum indicates that the type of the command is part of a whitelist of authorized command types or does not appear on a blacklist of unauthorized command types.

Preferably, the method comprises the storing (108) of the generated alert in a memory.

Preferably, at least one of the following data is stored in the memory in association with the generated alert: all or part of the data extracted from the command, a date on which the command was intercepted, and a slave recipient of the command.

Preferably, the method comprises the displaying of the alert on a display screen, instead and in place of another previously generated alert.

Provision is also made, according to a second aspect, for a device for monitoring a current loop, the device comprising:
a communication interface configured to intercept a command in accordance with the HART protocol circulating over a current loop,
a processing unit configured to: i) extract the data from the command, the extracted data comprising a first datum indicating whether or not the command was transmitted by a primary master or by a secondary master in the sense of the HART protocol, and a second datum indicating a type of the command; and ii) for generating or not generating an alert according to the extracted data, the alert indicating that the command is potentially abnormal and/or hazardous.

### DESCRIPTION OF THE FIGURES

Other features, aims and advantages of the invention will become apparent from the following description, which is purely illustrative and non-limiting, and which must be read with reference to the appended drawings, wherein:

FIG. 1 schematically illustrates different devices interconnected by a current loop, according to an embodiment.

FIG. 2 schematically represents a monitoring device according to an embodiment.

FIG. 3 is an organizational chart of steps of a method according to an embodiment, implemented by a monitoring device.

In all the figures, similar elements bear identical reference numbers.

### DETAILED DESCRIPTION OF THE INVENTION

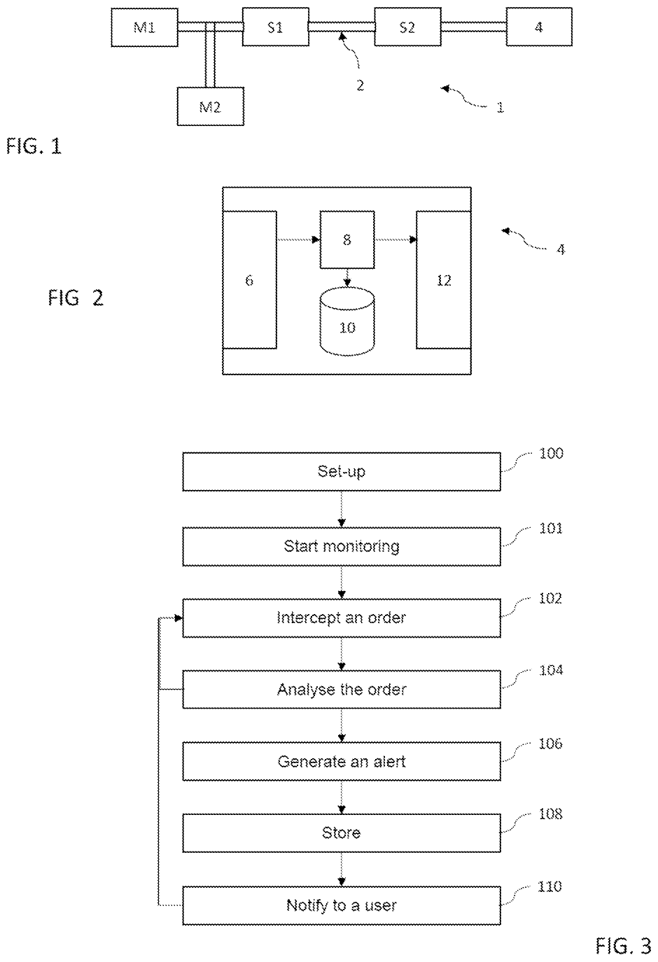

With reference to FIG. 1, a system 1 comprises a plurality of devices interconnected by a current loop 2.

The devices communicate with one another via the current loop 2 using signals in accordance with the HART protocol.

The plurality of devices comprises two master devices M1, M2, and at least one slave device S1, S2 (both in the example shown on FIG. 1).

Each master device, more simply referred to as “master” in the following text, is a device configured to generate commands in accordance with the HART protocol and inject them into the current loop 2, these commands being designed to be processed by a slave device.

Each slave device, more simply referred to as “slave” in the remainder of the text, is configured to detect on the current loop 2 the commands that are addressed to it, and to process them. For example, a slave device can be a sensor, a positioner, a controller etc. The slave devices can typically be used in one of the following applications: petrochemistry, heat production, control of water and/or heat networks, locks, river network systems etc.

Different types of commands can be generated by a master device. In this text, the term “type” of command should be understood to mean an item of information that characterizes the requested task to a recipient slave.

For example, certain commands are commands intended to act on an installation (opening a valve, modifying a temperature, changing a parameter of the configuration etc.). These commands are so-called “write” commands since they are intended to make a modification of the status of the slave. Other commands are status commands, asking a recipient slave to transmit a reply informing the issuing master about its internal state. These commands are so-called “read” commands. Other commands ask a slave to update one of its internal parameters (name, password, etc.).

The device M1 is a “primary” master in the sense of the HART protocol, and the device M2 is a “secondary” master in the sense of the HART protocol.

The primary master M1 is conventionally used by a manufacturer for system maintenance purposes, generally intermittently. In contrast, the secondary master M2 is used by an operator much more frequently, not for maintenance purposes, but for the slaves to perform certain actions.

The system 1 further comprises a monitoring device 4.

With reference to FIG. 2, the monitoring device 4 comprises a communication interface 6 connectable to the current loop 2, and a processing unit 8.

The communication interface 6 is, in general, configured to intercept HART commands circulating over the current loop 2. The communication interface may comprise one or more HART modems, and a galvanic isolator which makes it possible to be insulated from the current loop 2 to avoid disrupting the 4/20 mA signal circulating over this loop.

The processing unit 8 is configured to analyze the commands intercepted by the communication interface.

The processing unit 8 can be of any type: processor, microprocessor, nanocomputer (for example, of Raspberry Pi type), or a programmable or non-programmable circuit (ASIC, FPGA, etc.).

The processing unit 8 is for example configured to execute a monitoring program comprising code instructions for this purpose.

The monitoring device 4 further comprises a memory 10 able to store certain data handled or generated by the processing unit.

The monitoring device 4 can also comprise a human-machine interface 12, allowing a user to interact with the device 4.

The human-machine interface 12 comprises an output interface to notify a user of alerts, for example visually and/or sonically. The output interface, typically by a display screen, on which certain graphic data can be displayed at the command of the processing unit.

The human-machine interface 12 moreover comprises an input interface allowing a user to control the operation of the device. The input interface for example comprises a mouse, or else a touch-sensitive screen. As a variant or as a complement, the input interface comprises one or more buttons associated with different actions. The or each button can be a physical button, or else be a virtual button displayed on a touch-sensitive display screen.

With reference to FIG. 3, the monitoring device 4 can be used as follows.

In a set-up step 100, the monitoring device 4 is set up. This set-up comprises powering the device and starting the monitoring program by the processing unit.

This set-up step 100 may also comprise the switching-on of an activity indicator light. The latter makes it possible to know that the program has started. However, no HART communications monitoring is yet operational at this stage.

Starting the program causes a menu to be displayed on the display screen. The activity indicator light can in particular be a virtual indicator light included in this menu.

In a step 101, the device starts a monitoring of the current loop 2. This step is for example triggered by pressing a button of the device 4 by the user, for example a button shown on the displayed menu.

The processing unit 8 controls the storage in the memory 10 of the date on which the monitoring was started.

The processing unit 8 analyses the communication ports of the device 4 and identifies the peripherals comprising FSK modems (used by the HART protocol). Moreover, a monitoring indicator light is switched on, so as to indicate to the user that the monitoring is started. For example, this indicator light is displayed on the display screen in green.

From this time onwards, a monitoring method is implemented by the monitoring device. This monitoring method comprises the following steps.

In an intercepting step 102, the communication interface 6 intercepts a command in accordance with the HART protocol circulating over the current loop 2.

In an analyzing step 104, the processing unit 8 extracts data contained in the intercepted command. The data extracted by the device comprise a first datum indicating whether or not the command was transmitted by a primary master or by a secondary master within the sense of the HART protocol, and a second datum indicating a type of the command.

The analyzing step thus comprises two particular analyses, which can be carried out in parallel: an analysis of the first datum, and an analysis of the second datum.

The analysis of the first datum can typically consist in comparing the first datum with a value indicative of a primary master.

Moreover, the analysis of the second datum may comprise a comparison between the second datum and reference data. The reference data for example take the form of a whitelist showing authorized types of command, or else the form of a blacklist showing unauthorized types of command.

In a step 106, the device generates or does not generate an alert according to the extracted data, the alert indicating that the command is potentially abnormal. In other words, the decision to generate or not generate an alert taken by the processing unit depends on what the first datum and the second datum indicates.

The alert is preferably generated when the first datum indicates that the transmitter is a primary master and/or when the second datum indicates an unauthorized command type. It is enough for one of these two conditions to be observed to generate the alert.

However, the alert is not generated when the following conditions are all met: the first datum indicates that the command was not transmitted by a primary master and the second datum indicates that the type of the command is part of a whitelist of authorized command types or does not appear on a blacklist of unauthorized command types.

For example, if the command is authorized, and it was transmitted by a secondary master, no alert is generated for this command.

When the alert is generated, the following steps are triggered by the processing unit.

In a step 108, the alert is stored in the memory 10 in association with all or part of the data extracted from the command, a date on which the command was intercepted, an identifier of a slave recipient of the command (which has been extracted from the command).

Moreover, in a step 110, the user is notified of the alert via the human-machine interface. This notification is for example done visually, by switching on an alert indicator light, for example red. This alert indicator light can be an indicator light displayed in the menu by the display screen. Alternatively or complementarily, this visual notification can be done by displaying a text message associated with the alert. Here are examples of text messages able to be displayed and/or stored in the memory 10:
“an authorized command X has been sent to the device 1 by a primary master”;
“an unauthorized command Y has been sent to the device 2”.

The steps 102, 104, 106, 108, 110 are repeated for each new command intercepted on the current loop 2.

It should be noted that the processing unit 8 can command the display, on the display screen, of a single alert text message at a time. In this case, provision is made for a dedicated area in the menu for the display of such a text message, and each new alert text message is displayed in this dedicated area, instead and in place of a previous text message, previously generated by the processing unit.

The monitoring device 4 may offer the user the possibility of acknowledging the last escalated alert, by pressing an acknowledgment button. The acknowledgment of the alert causes the cessation of the display of the alert, or in other words, the switching-off of the alert indicator light and the erasure of the text message displayed in the dedicated area. On the other hand, the acknowledgment does not erase the data which have been stored in the memory 10.

The monitoring device 4 can moreover offer the user the possibility of suspending the monitoring, for example by pressing again on the button that was used to start the monitoring. In this case, the monitoring suspension date is stored in the memory 10.

1. A method implemented by a monitoring device for monitoring a current loop, the method comprising:
intercepting a command in accordance with the HART protocol circulating over a current loop,
extracting data from the command, wherein the data comprises a first datum indicating whether or not the command was transmitted by a primary master in the sense of the HART protocol, and a second datum indicating a type of the command,
generating, or not generating, an alert according to the data, the alert indicating that the command is potentially abnormal or hazardous.

2. The method of claim 1, wherein the alert is generated if the first datum indicates that the transmitter is a primary master.

3. The method of claim 1, further comprising comparing the type of the command indicated by the second datum with reference data, wherein the alert is generated or not generated according to the comparing.

4. The method of claim 1, wherein the alert is not generated whenever all the following conditions are met: the first datum indicates that the command was not transmitted by a primary master and the second datum indicates that the type of the command is part of a whitelist of authorized command types or is not part of a blacklist of unauthorized command types.

5. The method of claim 1, comprising storing the generated alert in a memory.

6. The method of claim 1, wherein at least one of the following data is stored in the memory in association with the generated alert:
all or part of the data extracted from the command,
a date on which the command was intercepted,
a slave recipient of the command.

7. The method of claim 1, comprising displaying the alert on a display screen in replacement of another previously generated alert.

8. A device for monitoring a current loop, the device comprising:
a communication interface configured to intercept a command in accordance with the HART protocol circulating over a current loop,
a processing unit configured to: i) extract data from the command, the data comprising a first datum indicating whether or not the command was transmitted by a primary master or by a secondary master in the sense of the HART protocol, and a second datum indicating a type of the command; and ii) generate or not generate an alert according to the data, the alert indicating that the command is potentially abnormal or hazardous.
